(19) United States
(12) Patent Application Publication
(10) Pub. No.: US 2010/0176749 A1
(43) Pub. Date: Jul. 15, 2010

(54) LIQUID CRYSTAL DISPLAY DEVICE WITH CLOCK SIGNAL EMBEDDED SIGNALING

(75) Inventor: Tzong-Yau Ku, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/352,665

(22) Filed: Jan. 13, 2009

(51) Int. Cl. H05B 37/02

(52) U.S. Cl. 315/360

(57) ABSTRACT

A display device includes a display panel, a timing controller generating a timing controlling signal having a plurality of states, each state representing both data information and clock information, and a source driver receiving and decoding the timing controlling signal to recover the data information and the clock information for generating a clock signal and a data signal for driving the display panel.

### BACKGROUND

1. Technical Field

The embodiments described herein relate to a display device, and more particularly, to a display device with an embedded clock signal.

2. Related Art

Recently, flat panel displays are increasingly being implemented in liquid crystal display and plasma display technologies, and as monitors for products, such as personal computers and television receivers. Commonly, circuits mounted to the flat panel displays consist of a timing controller, a power unit, a gate voltage generating unit, data driver ICs, and gate driver ICs. In display devices having a large-size and high-resolution screens, solutions for preventing electromagnetic interference (EMI) due to transmission lines, especially at an interface between the timing controller and the driver ICs, have become necessary.

In order to overcome the EMI, while at the same time accomplishing high speed data transmission with low power consumption, a large variety of standards for interfaces adopting differential signaling methods have been developed, such as reduced swing differential signaling (RSDS), mini-low voltage differential signaling (Mini-LVDS), and point-to-point differential signaling (PPDS).

FIG. 1 is a schematic diagram of a conventional display device utilizing an RSDS standard, and FIG. 2 is a schematic diagram of a conventional display device utilizing a mini-LVDS standard. In FIGS. 1 and 2, the display device 100 or 200 comprises one or more data signal lines 12 (differential signal lines) for sending data signals ‘DATA’ and a single clock signal line (differential signal line) 11 separate from the data lines 12 for sending a single clock signal ‘CLOCK’ that is synchronized with the data signals ‘DATA’. The display device 100 (or 200) employs a multi-drop method, wherein a plurality of source drivers 110_1 to 110_{—}m share the same clock signal line 11. This configuration is disadvantageous because the maximum operating speed is limited due to a large load of the clock signal ‘CLOCK’. Moreover, the data transmission is vulnerable to signal distortion and greater EMI due to impedance mismatch at the points where signal lines are split.

FIG. 3 is a schematic diagram of a conventional display device utilizing an PPDS standard. In FIG. 3, the display device 300 includes a plurality of clock signals ‘CLOCK_1’ to ‘CLOCK_m’ that are transmitted to respective source drivers 310_1 to 310_{—}m, thus solving the problems of large loading of a single clock signal that is suffered by the display devices in FIGS. 1 and 2 that employs the RSDS or min-LVDS standard. Additionally, a plurality of data signal lines 32_1 to 32_{—}m are connected respectively to the source drivers 310_1 to 310_{—}m for transmitting data signals ‘DATA_1’ to ‘DATA_m’, respectively, thus reducing the impedance mismatch and hence EMI. However, higher transmission speeds of the clock signals ‘CLOCK_1’ to ‘CLOCK_m’ are required in most applications, thereby resulting in implementation of separate clock signal lines 31_1 to 31_{—}m. This induces higher fabrication costs. Moreover, a skew is inevitable between a data signal ‘DATA_i’ and a clock signal ‘CLOCK_i’ (i is an integer between 1 and m) sampling the data signal ‘DATA_i’, thus resulting an inaccurate sampling process or requiring additional circuits for compensating for the skew.

Another configuration (not shown) has also been proposed recently to solve the impedance mismatch and EMI problems by transmitting a clock signal sequentially to the source drivers connected in a chain. However, the clock signal is delayed between the source drivers, thus causing a failed data sampling.

### SUMMARY

A display device and multi-level signaling method capable of improving EMI characteristics and clock sampling are described herein.

In one aspect, a display device includes a display panel, a timing controller generating a timing controlling signal having a plurality of states, each state representing both data information and clock information, and a source driver receiving and decoding the timing controlling signal to recover the data information and the clock information for generating a clock signal and a data signal for driving the panel.

In another aspect, a signaling method between a timing controller and a source driver in a display device includes generating a timing controlling signal having a plurality of states, each state representing both data information and clock information, and receiving and decoding the timing controlling signal to recover the data information and the clock information for generating a clock signal and a data signal.

In another aspect, a display device includes a display panel, a timing controller generating a timing controlling signal having a plurality of states, each state representing one of a logic high and a logic low of a data signal supplied to the display panel, and further represents one of a logic high and a logic low of a clock signal supplied to the display panel, and each state has at least one voltage level different from those of other states, a plurality of comparators configured to compare the at least one voltage level of the timing controlling signal to at least one predetermined voltage to generate the data signal, an OR gate generating the clock signal according to outputs of the plurality of comparators, and a delay logic unit configured to delay one of the data signal generated by the comparators and the clock signal generated by the OR gate.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a schematic diagram of a conventional display device utilizing an RSDS standard;

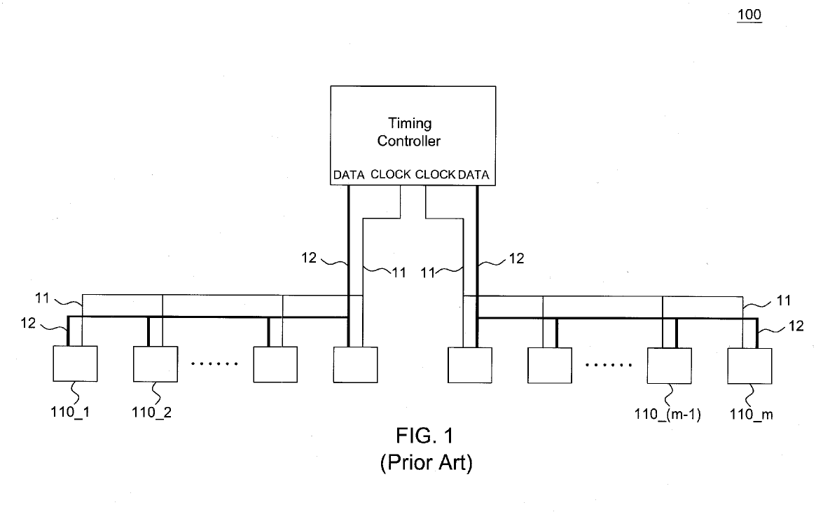

FIG. 2 is a schematic diagram of a conventional display device utilizing a mini-LVDS standard;

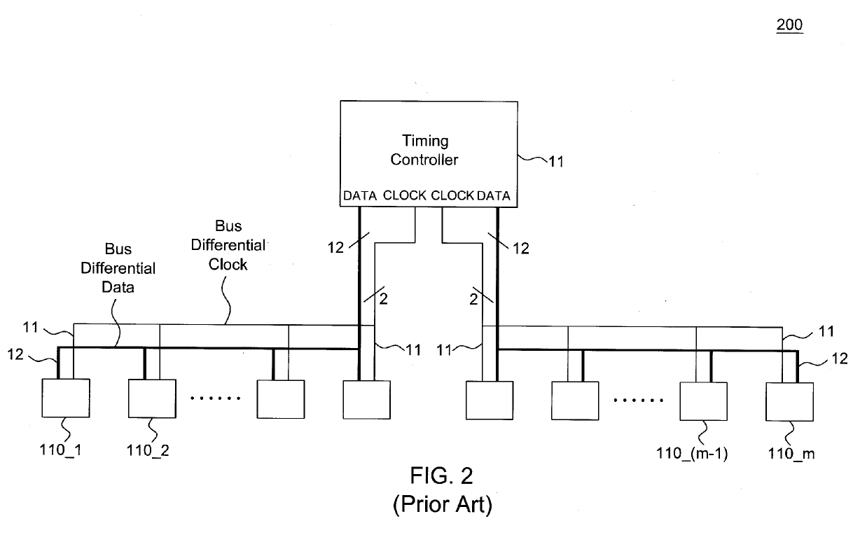

FIG. 3 is a schematic diagram of a conventional display device utilizing an PPDS standard;

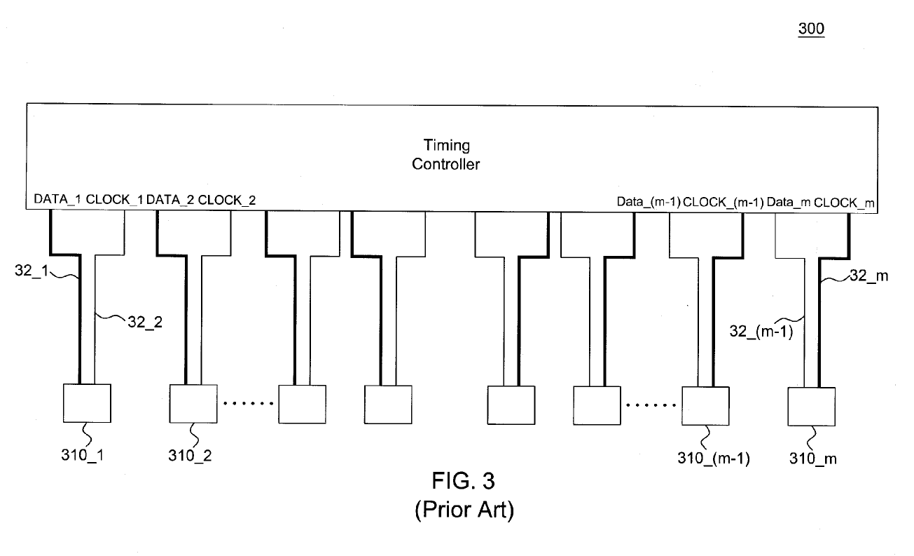

FIGS. 4A and 4B are schematic diagrams of exemplary display devices according to one embodiment;

FIG. 5A is a table summarizing state numbers and corresponding predetermined data and clock values of the timing controlling signal of FIG. 4A according to one embodiment;

FIG. 5B is a table summarizing state numbers and corresponding predetermined data and clock values of the timing controlling signal of FIG. 4B according to another embodiment;

FIGS. 6A and 6B are a table summarizing the voltage levels of a timing controlling signal and a schematic diagram demonstrating a relationship of the voltage levels of FIG. 6A with two DC predetermined voltages according to one embodiment;

FIGS. 7A and 7B are a table summarizing the voltage levels of a timing controlling signal and a schematic diagram demonstrating a relationship of the voltage levels of FIG. 7A with a DC predetermined voltage according to another embodiment;

FIG. 8 is a schematic diagram of an exemplary decoder of a source driver employing a 4-state timing controlling signal according to one embodiment;

FIG. 9 is a schematic diagram of another exemplary decoder of a source driver employing a 4-state timing controlling signal according to another embodiment;

FIGS. 10A and 10B are diagrams demonstrating exemplary signal values for a 4-state timing controlling signal and corresponding waveforms of typical signals, respectively, according to one embodiment;

FIG. 11A is a schematic diagram of another exemplary display device according to another embodiment; and

FIG. 11B is a schematic diagram of further another exemplary display device according to further another embodiment.

### DETAILED DESCRIPTION

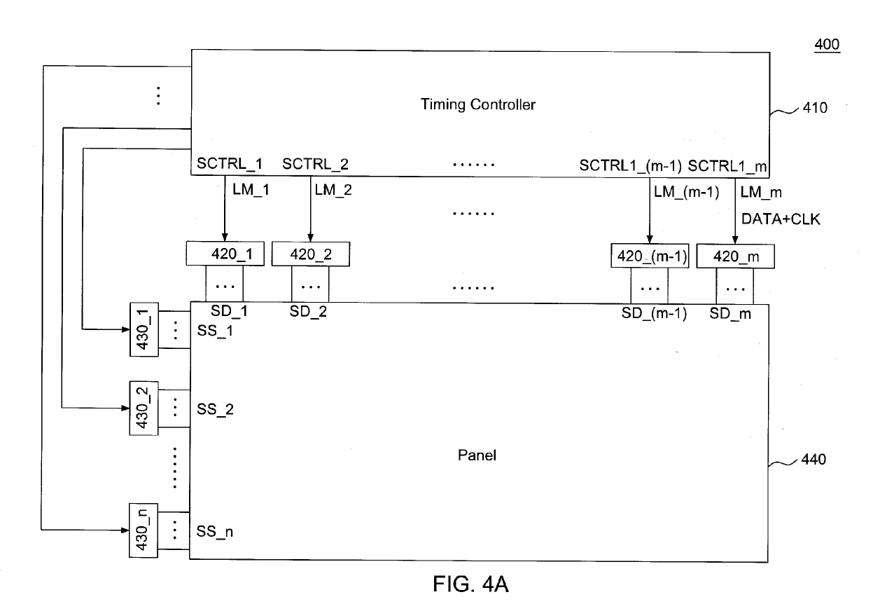

FIGS. 4A and 4B are schematic diagrams of exemplary display devices according to one embodiment. In FIGS. 4A and 4B, the display device 400 can be configured to include a timing controller 410, source drivers 420_1 to 420_{—}m, gate drivers 430_1 to 430_{—}n, multi-information signal lines LM_1 to LM_m, and a panel 440 (m is a non-zero integer).

The timing controller 410 can be configured to deliver timing controlling signals SCTRL_1 to SCTRL_m to the corresponding source drivers 420_1 to 420_{—}m through the corresponding multi-information signal lines LM_1 to LM_m. The source drivers 420_1 to 420_{—}m can be configured to convert the received timing controlling signals ‘SCTRL_1’ to ‘SCTRL_m’ and provide data signal ‘SD_1 ’ to ‘SD_m’ to a panel 440.

The gate driver 430 can be configured to provide scan signals ‘SS_1’ to ‘SS_n’ to the panel 440. The panel 440, such as a LCD panel, an OLED panel, and a PDP panel, can be configured to display video frames according to the data signals ‘SD_1’ to ‘SD_m’ and the scan signals ‘SS_1’ to ‘SS_n’.

For example, the information carried by each timing controlling signal ‘SCTRL_i’ (i is an integer between 1 and m) on a corresponding multi-information signal line LM_i can include a plurality of kinds of information, such as clock information and data information. Here, clock information can be embedded in the timing controlling signal ‘SCTRL_i’. Particularly, each timing controlling signal ‘SCTRL_i’ can have a plurality of states STATE_i,1, STATE_i,2, . . . , STATE_i,p (wherein p is defined as the total state number and is a non-zero integer), wherein each state STATE_i,j (j is the state number, and is an integer between 1 and p) can represent a plurality of kinds of information, rather than to a single kind of information. In a preferable embodiment, each state STATE_i,j represents, at least, both clock information and data information. The timing controlling signal ‘SCTRL_i’ can transition between different states STATE_i,1, STATE_i,2, . . . , and STATE_i,p along time, so as to simultaneously convey respective clock and data information that are represented by the states.

For example, each state STATE_i,j in the embodiment is representative both of a predetermined clock signal value ‘CLOCK_i,j’ and a predetermined data signal value ‘DATA_i,j’. The timing controlling signal ‘SCTRL_i’ can transition between different states STATE_i,1, STATE_i,2, . . . , and STATE_i,p to simultaneously provide the source driver 420_{—}i with different predetermined clock signal values and different predetermined data signal values that both correspond to the different states. Preferably, the total state number p is 4, and the four states respectively correspond to (DATA, CLOCK)=(1,1), (1,0), (0,0), and (0,1) (the sequence is only an example and the invention is not limited thereto).

In FIG. 4B, each source driver 420_{—}i can be configured to include a respective decoder 450_{—}i to decode the corresponding timing controlling signal ‘SCTRL_i’ to recover data information and clock information transmitted from the timing controller 410. For example, the decoder 450_{—}i can be configured to detect the state of the timing controlling signal ‘SCTRL_i’ to obtain the respective data information and clock information that are represented by the detected state.

In FIGS. 4A and 4B, only a single-type of signal line, namely the multi-information signal line LM_i, can be implemented between the timing controller 410 and the corresponding source driver 420_{—}i. In addition, only a single-type of signal, namely the timing controlling signal ‘SCTRL_i’, can be used to carry both clock information and data information by transitioning between states each corresponding both to a clock signal value and a data signal value.

In FIG. 4A, the display device 400 illustratively employs a “point-to-point” scheme, wherein each of the plurality of source drivers 420_1 to 420_{—}m can be connected to the timing controller 410 through a respective multi-information signal line, without sharing the same signal line. However, “one-point-to-multiple points” can be used.

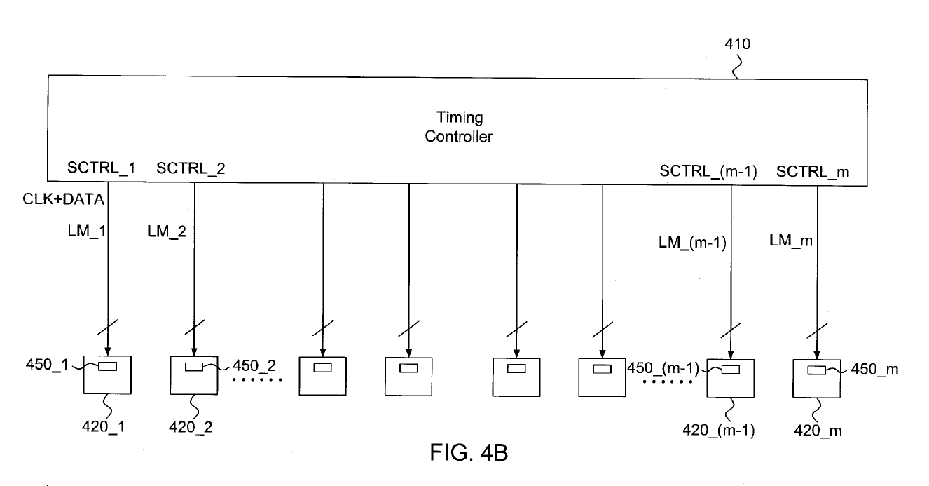

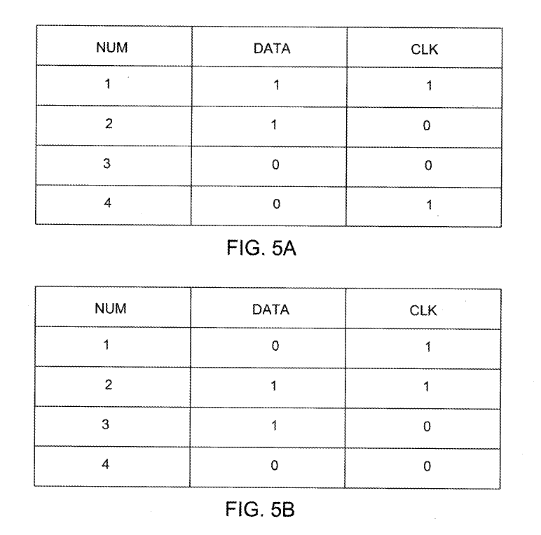

FIG. 5A is a table summarizing state numbers and corresponding predetermined data and clock signal values of the timing controlling signal of FIG. 4A according to one embodiment, and FIG. 5B is a table summarizing state numbers and corresponding predetermined data and clock values of the timing controlling signal of FIG. 4B according to another embodiment. In FIGS. 5A and 5B, where the total state numbers ‘p’, for example, are both equal to 4, that is, the timing controlling signal ‘SCTRL_i’ can transition between four states STATE_i,1 to STATE_i,4 (i is any integer between 1 and m). Here, the number of each state is indexed by a parameter NUM. In FIG. 5A, the 4 states represent (DATA, CLOCK)=(1,1), (1,0), (0,0), and (0,1), and in FIG. 5B, the 4 states represent (DATA, CLOCK)=(0,1), (1,1), (1,0), and (0,0).

In FIG. 5A, during enable periods when valid data information is transmitted, or the source driver 420_{—}i is enabled to receive the data information, the clock signal value ‘CLOCK’ can be required to transition back and forth between 0 and 1, that is, in a transition pattern of CLOCK=(1→0→1→0→ . . . ). However, the data signal value ‘DATA’ during these enabled periods is not required to have any specific transition pattern. As a result, the state of the timing controlling signal can be required to transition with a pattern as (NUM)=(1 or 4→2 or 3→1 or 4→2 or 3→ . . . ). For example, the state of the timing controlling signal in a certain period transitions as: (NUM)=(1→3→4→2), meaning that clock and data information received by the corresponding source driver are CLOCK=(1→0→1→0) and data information DATA=(1→0→0→1), respectively.

In FIG. 5B, the state of the timing controlling signal ‘SCTRL’ is required for similar reason to transition with a pattern as (NUM)=(1 or 2→3 or 4→1 or 2→3 or 4, . . . ). In comparison of FIGS. 5A and 5B, FIG. 5A can provide an additional confirmation mechanism on transmission accuracy. The swing of the state number NUM in FIG. 5A can only be 1 or 2, which allows detection of an error if a swing of 3 occurs. In contrast, the swing of the state number NUM in FIG. 5B can be 1, 2, or 3, thus being unable to provide a confirmation mechanism.

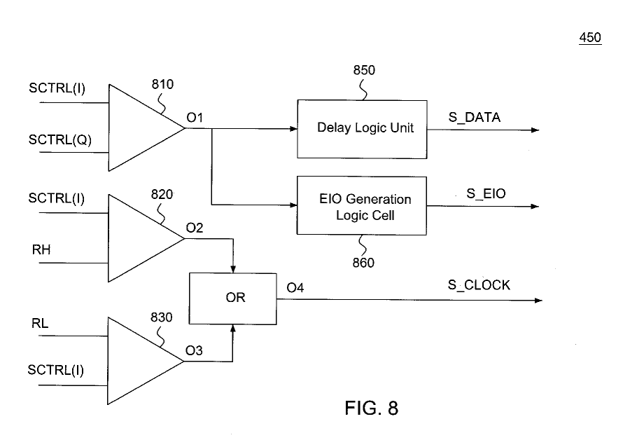

During disable periods when no valid data information is transmitted, or the source driver 420_{—}i is disabled to receive data information, the clock signal value ‘CLOCK’ can be required to be maintained at 0. Additionally, the states of the timing controlling signals in FIGS. 5A and 5B during a disable period can be further set to transition with a specific pattern, for example, (NUM)=( . . . 2→3→2→3 . . . ) and ( . . . 3→4→3→4), respectively, such that the decoder 450_{—}i can be configured to determine the end of a disable period by detecting the state pattern of the timing controlling signal ‘SCTRL_i’, as is detailed below with reference to FIGS. 8, 9, 10A, and 10B.

In FIGS. 4A and 4B, the timing controlling signal ‘SCTRL_i’ can be a single-ended signal, or preferably, it can also be a pair of differential signals. Additionally, various electric characteristics of the timing controlling signal ‘SCTRL_i’, such as voltage level, current level, and etc., can be used to set the timing controlling signal ‘SCTRL_i’ in different states. With the timing controlling signal ‘SCTRL_i’ set in different states by different corresponding current/voltage levels, the respective decoder 450_{—}i in the source driver 420_{—}i can be configured to decode the timing controlling signal ‘SCTRL_i’ by comparing the current/voltage level of the timing controlling signal ‘SCTRL_i’ with at least one predetermined current/voltage level to recover the data information and the clock information.

For example, the timing controlling signal ‘SCTRL_i’ can be a single-ended signal that can transition between a p-number of different voltage levels V_1 to V_p, where p represents a total state number. In other words, each state has a respective voltage level of the voltage levels V_1 to V_p. In another example, the timing controlling signal ‘SCTRL_i’ can be a pair of differential signals ‘SCTRL_i(I)’ and ‘SCTRL_(Q)’, either of which can transition between different voltage levels. Specifically, for each state STATE_i,j of the timing controlling signal ‘SCTRL_i’, the differential signal ‘SCTRL_i(I)’ can have a respective level V(I)_i,j that transitions between a first plurality of voltage levels V(I)_i,1 to V(I)_i,q1, and the other differential signal ‘SCTRL_i(Q)’ can have a respective level V(Q)_i,j that transitions between a second plurality of voltage levels V(Q)_i,1 to V(Q)_i,q2 (q1 and q2 are non-zero integers). In other words, each state has two respective voltage levels, one of the first plurality of voltage levels V(I)_i, 1 to V(I)_i,q1, the other of the second plurality of voltage levels V(Q)_i,1 to V(Q)_i,q2. Preferably, q1=q2. More preferably, q1≧3 and q2≧3.

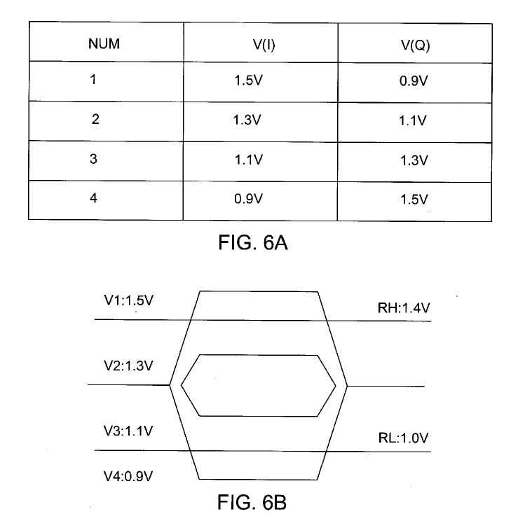

FIG. 6A is a table summarizing the voltage levels of a pair of differential signals that serve as a timing controlling signal in different states with q1=q2=4 and p=4 according to one embodiment. As shown, the voltage levels V(I) and V(Q) of the differential signals ‘SCTRL_i(I)’ and ‘SCTRL_i(I)’, collectively denoted as (V(I), V(Q)) herein, can be set to (1.5, 0.9), (1.3, 1.1), (1.1, 1.3), and (0.9, 1.5) for the state number NUM: 1, 2, 3, and 4, respectively.

FIG. 6B is a schematic diagram demonstrating an exemplary relationship of the voltage levels of FIG. 6A with two DC predetermined voltages according to one embodiment. As shown, two DC voltages RH=1.4V and RL=1.0V are depicted together with the respective four voltage levels of the differential signals ‘SCTRL_i(I)’ and ‘SCTRL_i(Q)’ to illustrate their relative magnitudes. The 4 voltage levels (V1, V2, V3, V4)=(1.5, 1.3, 1.1, 0.9) and the two DC voltages RH=1.4V and RL=1.0V construct a symmetric relationship. The two DC voltages RH and RL can be provided to the source drivers 420_1 to 420_{—}m in decoding the differential signals for defining the four voltage levels V1-V4, as is detailed below with reference to FIG. 8.

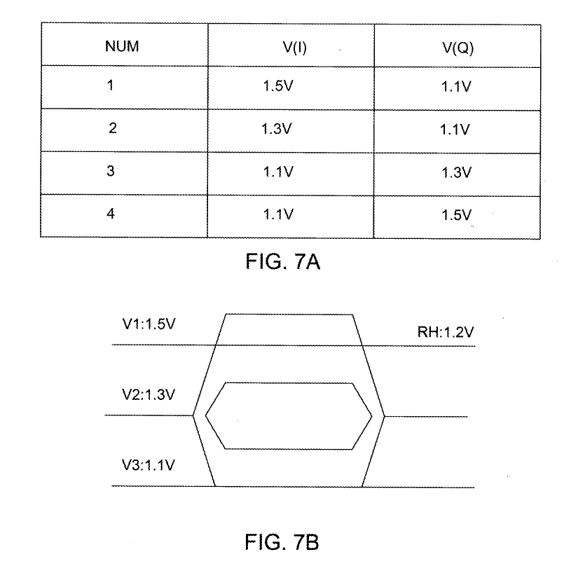

FIG. 7A is a table summarizing the voltage levels of a pair of differential signals serve as a timing controlling signal in different states with q1=q2=3 and p=4 according to another embodiment. As shown, (V(I), V(Q)) are set to (1.5, 1.1), (1.3, 1.1), (1.1, 1.3), and (1.1, 1.5) respectively for the state number NUM: 1, 2, 3, and 4.

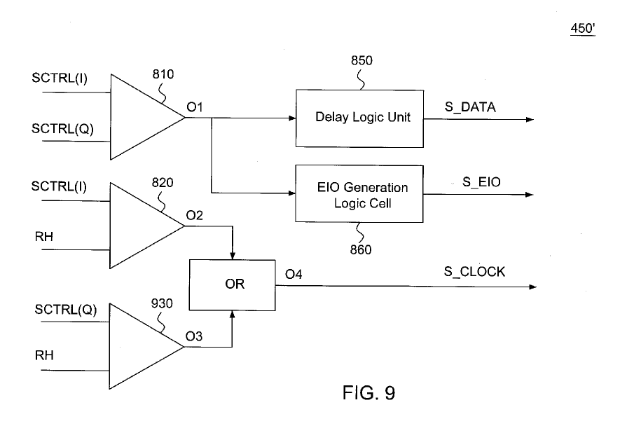

FIG. 7B is a schematic diagram demonstrating an exemplary relationship of the voltage levels of FIG. 6A with a DC predetermined voltage according to one embodiment. As shown, the DC voltage RH=1.2V is depicted together with the respective three voltage levels of the differential signals ‘SCTRL_i(I)’ and ‘SCTRL_i(Q)’ for illustrating their relative magnitudes. As shown, the 3 voltage levels (V1, V2, V3)=(1.5, 1.3, 1.1) and the DC voltage RH=1.2V have an asymmetric relationship. The DC voltage RH can also be provided to the source drivers 420_1 to 420_{—}m in decoding the differential signals for defining the three voltage levels V1-V3, as is detailed below with reference to FIG. 9.

FIG. 8 is a schematic diagram of an exemplary decoder of a source driver employing a 4-state timing controlling signal according to one embodiment. In FIG. 8, the schematic diagram of the decoder 450_{—}i of the source driver 420_{—}i (1≦i≦m) of FIGS. 4A and 4B is shown, where the source driver 420_{—}i employs a pair of 4-level (q1=q2=4) differential signals ‘SCTRL_i(I)’ and ‘SCTRL_i(Q)’ as a 4-state (total state number p=4) timing controlling signal ‘SCTRL_i’, as shown in FIGS. 6A and 6B. The decoder 450 is configured to receive the differential signals ‘SCTRL_i(I)’ and ‘SCTRL_i(Q)’ and two predetermined voltages RH and RL to recover the clock information and data information.

A comparator 810 compares the voltage levels of the differential signals ‘SCTRL_i(I)’ and ‘SCTRL_i(Q)’ to obtain an output O1. The decoder 450_{—}i can employ the output O1 as a data signal ‘S_DATA’ that provides data information; or preferably, the decoder 450_{—}i can further comprise a delay logic unit 850 that delays the output O1 by a required phase (e.g., 1800) to generate the data signal ‘S_DATA’, as shown in FIG. 8.

A comparator 820 compares the voltage level of the differential signal ‘SCTRL_i(I)’ with the predetermined voltage RH to provide the comparison result as an output O2. Similarly, a comparator 830 compares the predetermined voltage RL with the voltage level of the differential signal ‘SCTRL_i(I)’ to provide the comparison result as an output O3. An OR gate 840 then generates an output O4 according to the outputs O2 and O3. With the implementation of the delay logic unit 850, the output O4 can be employed directly as a clock signal ‘S_CLOCK’ providing clock information, or in an alternative, without the delay logic unit 850, the decoder 450_{—}i can further comprise a delay logic unit (not shown) that delays the output O4 of the OR gate 840 by a required phase (e.g., 180°) to generate the clock signal ‘S_CLOCK’.

Preferably, the decoder 450_{—}i can further comprise an enable input/output (EIO) generation logic cell 860 to provide an enable input/output signal ‘S_EIO’. The enable input/output signal ‘S_EIO’ can be used to control the output of the decoder 450_{—}i, enabling or disabling the source driver 420_{—}i to receive the data signal ‘S_DATA’ and clock signal ‘S_CLOCK’ for successive processing after decoding.

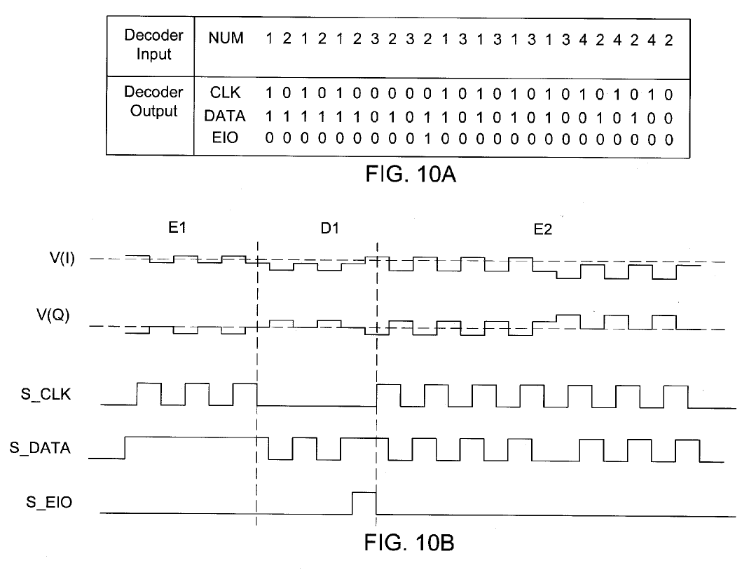

In FIG. 8, the EIO generation logic cell 860 can be configured to receive the output O1. The EIO generation logic cell 860 can then detect the state pattern of the timing controlling signal ‘SCTRL_i’ according to the received output O1 in generating the enable input/output signal ‘S_EIO’, as is detailed below with reference to FIGS. 10A and 10B.

FIG. 9 is a schematic diagram of another exemplary decoder of a source driver employing a 4-state timing controlling signal according to another embodiment. In FIG. 9, the schematic diagram shows the decoder 450_{—}i′ of the source driver 420_{—}i (1≦i≦m) of FIGS. 4A and 4B, where the source driver 420_{—}i employs a pair of 3-level (q1=q2=3) differential signals ‘SCTRL_i(I)’ and ‘SCTRL_i(Q)’ as a 4-state (total state number p=4) timing controlling signal ‘SCTRL_i’, as shown in FIGS. 7A and 7B. Here, FIG. 9 differs from FIG. 8 mainly in that the comparator 830 can be replaced with a comparator 930 that compares the voltage level of the differential signal ‘SCTRL_i(Q)’ and the predetermined voltage RH instead. For the sake of brevity, details similar to those in FIG. 8 are omitted below.

FIGS. 10A and 10B are diagrams demonstrating exemplary signal values for a 4-state timing controlling signal and corresponding waveforms of typical signals, respectively, according to one embodiment. Here, FIG. 10A shows the state number NUM, the corresponding clock signal value ‘CLOCK’ and data signal value ‘DATA’, and an input/output enable signal value ‘EIO’ for the 4-state (i.e. the total state number p=4) timing controlling signal of FIG. 5A. FIG. 10B illustrates the waveforms of the 4-level differential signals ‘SCTRL_i(I)’ and ‘SCTRL_i(Q)’, the clock signal ‘S_CLCCK’, the data signal ‘S_DATA’, and the enable input/output signal ‘S_EIO’ that correspond to FIG. 10A with the implementation as the decoder 450 in FIG. 8. As shown, the differential signals ‘SCTRL_i(I)’ and ‘SCTRL_i(Q)’ transition between different states along time, simultaneously conveying clock signal value and data signal value by each of the states at any time point.

During enable periods E1 and E2, the state number NUM switches with a pattern as (NUM)=(1 or 4→2 or 3→1 or 4→2 or 3→ . . . ), which reflects a requirement that clock signal value ‘CLOCK’ has to transition back and forth between 0 and 1, as described in connection with FIG. 5A.

On the other hand, during a disable period D1, the state number NUM can be set to transition in a specific state pattern, such as (2→3→2→3→2→ . . . ), which represents clock signal value ‘CLOCK’ (0→0→0→0→0→ . . . ) and data signal value ‘DATA’ (1→0→1→0→1→ . . . ). The state pattern of the clock signal value ‘CLOCK’ reflects a requirement that clock signal value ‘CLOCK’ has to be maintained at 0 when the source driver 420_{—}i is disabled to process decoded output signals (‘S_DATA’ and ‘S_CLOCK’) from decoder 450_1, as described in connection with FIG. 5A. However, the state pattern (1→→0→1→0→1) of the data signal value ‘DATA’ is from an additional requirement of the embodiment that is made for generation of the enable input/output signal ‘S_EIO’, in view that the end of a specific pattern such as (2→3→2→3→2) can be detected so can be used to provide an indication of the end of a disable period, i.e., as a prompt for enabling the source driver 410_{—}i.

For example, the decoder 450_{—}i can be configured to generate an enable input/output signal ‘S_EIO’ for enabling the source driver 410_{—}i according to the state pattern of the timing controlling signal ‘SCTRL_i’. Specifically, during a disable period, such as D1, the timing controller can provide the timing controlling signal having state number NUM transitioning with a specific pattern such as (2→3→2→3→2→ . . . ). Meanwhile, the decoder 450_{—}i detects the state pattern of the timing controlling signal so as to detect the end of the disable period and start a succeeding enable period. If the decoder 450_{—}i detects that the state number NUM terminates transitioning with the specific pattern, the decoder 450_{—}i can generate a pulse for the enable input/output signal ‘S_EIO’ to enable the source driver 410_{—}i. The corresponding implementation is illustrated in FIG. 8, wherein the EIO generation logic cell 860 detects the state pattern of the timing controlling signal ‘SCTRL_i’ after receiving to the output O1 to generate the enable input/output signal ‘S_EIO’.

In FIG. 10B, the clock signal ‘S_CLOCK’ and the data signal ‘S_DATA’ can have about a 180° (degree) phase difference. The corresponding implementation is illustrated in FIG. 8, where the delay logic unit 850 delays the output O1 to generate the data signal ‘S_DATA’. For the sake of brevity, similar descriptions for a case of the 3-level differential signal, as shown in FIGS. 7A, 7B, and 9, are omitted below.

It should be noted that the source drivers 420_1 to 420_{—}m are connected according to a point-to-point scheme. However, the source drivers 420_1 to 420_{—}m can be connected in any one-point to-multiple-points scheme.

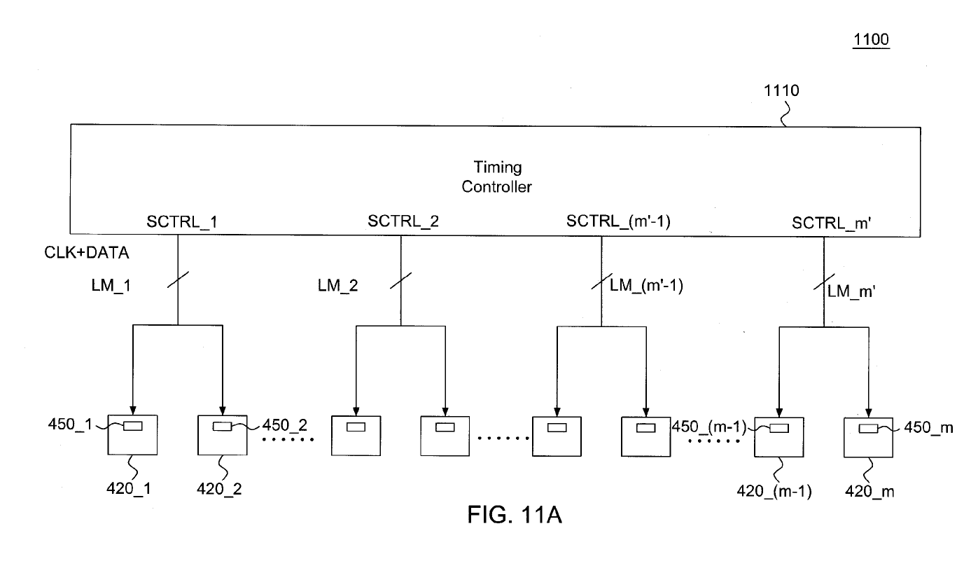

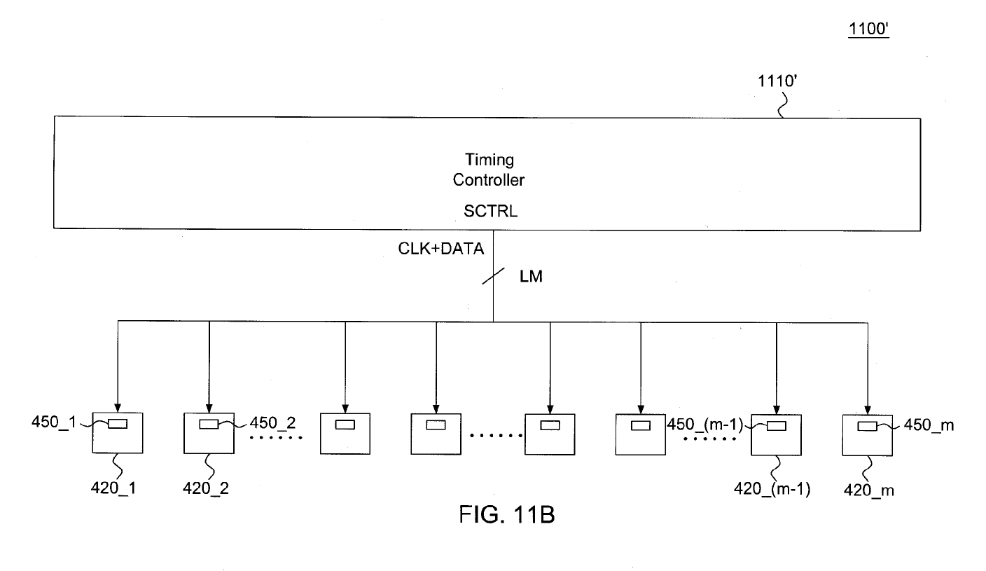

FIG. 11A is a schematic diagram of another exemplary display device according to another embodiment, and FIG. 11B is a schematic diagram of further another exemplary display device according to further another embodiment. Here, FIGS. 11A and 11B demonstrate the structures of display devices 1100 and 1100′ that employ a point-to-couple scheme and a 1-point-to-m pints scheme, respectively (m is an integer). The main difference between FIGS. 11A and 11B and FIGS. 4A and 4B is that the data amount represented by the respective timing controlling signals generated by timing controllers 1110 and 1110′ is increased by 2 and m times, respectively, so the total state numbers of the respective timing controlling signals can be increased to represent more data. For the sake of brevity, the discussion of similar features to those in FIGS. 4A and 4B have been omitted

In the embodiments described above, since only a single-type of signal line is disposed between the timing controller and a corresponding source driver, the total number of signal lines and the manufacturing costs can be reduced. Additionally, since a single timing controlling signal is used to carry both clock information and data information, a more accurate data sampling without implementation of an additional de-skew can be achieved. Additionally, due to one or more multi-information signal lines that can be disposed respectively for source driver(s), problems can be solved such as large signal loading, EMI and failed data sampling caused by signal delay, and consequently, higher transmission speed can also be provided.

While certain embodiments have been described above, it will be understood that the embodiments described are by way of example only. Accordingly, the device and methods described herein should not be limited based on the described embodiments. Rather, the device and methods described herein should only be limited in light of the claims that follow when taken in conjunction with the above description and accompanying drawings.

What is claimed is:

1. A display device, comprising:
a display panel;
a timing controller generating a timing controlling signal having a plurality of states, each state representing both data information and clock information; and
a source driver receiving and decoding the timing controlling signal to recover the data information and the clock information for generating a clock signal and a data signal for driving the display panel.

2. The display device of claim 1, wherein the timing controlling signal is a single-ended signal having the states, each state having a voltage level different from those of the other states.

3. The display device of claim 1, wherein each state of the timing control signal represents one of a logic high and a logic low of the data signal, and further represents one of a logic high and a logic low of the clock signal.

4. The display device of claim 1, wherein the timing controlling signal has 4 states including:
a first state representing a logic high of the data signal and a logic high of the clock signal;
a second state representing a logic high of the data signal and a logic low of the clock signal;
a third state representing a logic low of the data signal and a logic low of the clock signal; and
a fourth state representing a logic low of the data signal and a logic high of the clock signal.

5. The display device of claim 1, wherein the timing controlling signal is a pair of differential signals, and for each state of the timing controlling signal, one of the pair of differential signals is at a respective level of a first plurality of current/voltage levels, and the other one of the pair of differential signals is at a respective level of a second plurality of current/voltage levels.

6. The display device of claim 5, wherein the numbers of the first and second pluralities of current/voltage levels are one of 3 and 4.

7. The display device of claim 5, wherein the source driver compares the current/voltage levels of the pair of differential signals and at least one predetermined current/voltage level to recover the data information and the clock information.

8. The display device of claim 1, wherein the source driver further decodes the timing control signal to generate an enable input/output signal.

9. The display device of claim 8, wherein the source driver generates the enable input/output signal according to a state pattern of the timing controlling signal.

10. The display device of claim 7, wherein the source driver comprises:
a first comparator comparing the voltage levels of the pair of differential signals to generate a data signal;
a second comparator comparing the voltage levels of one of the pair of differential signals and a predetermined voltage;
a third comparator comparing the voltage levels of one of the pair of differential signals and a predetermined voltage; and
an OR gate generating a clock signal according outputs of the second and third comparators.

11. The display device of claim 10, further comprising a delay logic unit configured to delay the data signal.

12. The display device of claim 10, further comprising a delay logic unit configured to delay the clock signal.

13. The display device of claim 10, wherein the source driver further comprises an enable input/output generation logic cell configured to generate an enable input/output signal for enabling the source driver according the output of the first comparator.

14. A signaling method between a timing controller and a source driver in a display device, comprising:
generating a timing controlling signal having a plurality of states, each state representing both data information and clock information; and
receiving and decoding the timing controlling signal to recover the data information and the clock information for generating a clock signal and a data signal.

15. The method of claim 14, wherein the timing controlling signal is a single-ended signal having the plurality of states, each state having a voltage level different from other states.

16. The method of claim 14, wherein each state of the timing control signal represents one of a logic high and a logic low of the data signal, and further represents one of a logic high and a logic low of the clock signal.

17. The method of claim 14, wherein the timing controlling signal has 4 states including:
a first state representing a logic high of the data signal and a logic high of the clock signal;
a second state representing a logic high of the data signal and a logic low of the clock signal;
a third state representing a logic low of the data signal and a logic low of the clock signal; and
a fourth state representing a logic low of the data signal and a logic high of the clock signal.

18. The method of claim 14, wherein the timing controlling signal is a pair of differential signals, and for each state of the timing controlling signal, one of the pair of differential signals is at a respective level of a first plurality of current/voltage levels, and the other one of the pair of differential signals is at a respective level of a second plurality of current/voltage levels.

19. The method of claim 18, wherein the numbers of the first and second pluralities of current/voltage levels are one of 3 and 4.

20. The method of claim 18, wherein recovering the data information and the clock information comprises comparing the current/voltages levels of the pair of differential signals and at least one predetermined current/voltage level.

21. The method of claim 14, further comprising decoding the timing control signal to generate an enable input/output signal.

22. The method of claim 21, wherein generation of the enable input/output signal is performed according to a state pattern of the timing controlling signal.

23. A display device, comprising:
a display panel;
a timing controller generating a timing controlling signal having a plurality of states, each state representing one of a logic high and a logic low of a data signal supplied to the display panel, and further represents one of a logic high and a logic low of a clock signal supplied to the display panel, and each state has at least one voltage level different from those of the other states;
a plurality of comparators configured to compare the at least one voltage level of the timing controlling signal and at least one predetermined voltage to generate the data signal;
an OR gate generating the clock signal according to outputs of the plurality of comparators; and
a delay logic unit configured to delay one of the data signal generated by the comparators and the clock signal generated by the OR gate.

24. The display device of claim 23, wherein the timing controlling signal is a pair of differential signals, and for each state of the timing controlling signal, one of the pair of the differential signals has a respective level of a first plurality of voltage levels as one of the at least one voltage level, and the other one of the pair of the differential signals has a respective level of a second plurality of voltage levels as the other one of the at least one voltage level.

25. The display device of claim 24, wherein the numbers of the first and second pluralities of voltage levels are 3 or 4.
